(19) United States
(12) Patent Application Publication
(10) Pub. No.: US 2010/0332285 A1
(43) Pub. Date: Dec. 30, 2010

(54) Intellectual Property Component Business Model for Client Services

(75) Inventors: Deborah Dunagan, Gainesville, GA (US); Rick Allen Hamilton, Charlottesville, VA (US); Brian Marshall O'Connell, Research Triangle Park, NC (US); Arvin Patel, Sunnyvale, CA (US); Keith Raymond Walker, Austin, TX (US)

Correspondence Address: CAHN & SAMUELS, LLP, 1100 17th STREET, NW, SUITE 401, WASHINGTON, DC, 20036, US

(73) Assignee: International Business Machines Corporation, Armonk, NY (US)

(21) Appl. No.: 12/490,595

(22) Filed: Jun. 24, 2009

(51) Int. Cl. G06Q 10/00; G06Q 50/00; G06F 17/30; G06Q 30/00

(52) U.S. Cl. 705/10; 705/7; 707/912; 707/955; 707/812

(57) ABSTRACT

An embodiment of the invention provides a computerized system for providing an IP framework, including a storage component, a user interface, and a reporting module. The storage component includes a collection of database tables having a capability field and keyword field. The database tables include data from a strategic planning computer module, an invent computer module, an IP creation computer module, an IP administration computer module, a defend computer module, an influence computer module, and a capitalize computer module. The user interface receives as input, an invention disclosure and/or a configuration file for an IP capability. The reporting module processes the input in the storage component and produces the IP framework.

### I. FIELD OF THE INVENTION

The present invention is in the field of systems, methods, and computer program products for an intellectual property component business model for client services.

### II. BACKGROUND OF THE INVENTION

Intellectual property (IP) is a legal field that refers to creations of the mind, such as musical, literary, and artistic works; inventions; and, symbols, names, images, and designs used in commerce. IP includes, among other things, copyrights, trademarks, patents, and related rights. Under IP law, the holder of one these “properties” has certain rights to the creative work, commercial symbol, or invention that is covered by it. IP confers a bundle of rights in relation to the particular form or manner in which ideas or information is expressed or manifested, and not in relation to the ideas or concepts themselves (the idea-expression divide). The term “intellectual property” denotes the specific legal rights which authors, inventors, and other IP holders may hold and exercise, and not the intellectual work itself.

### III. SUMMARY OF THE INVENTION

An embodiment of the invention provides a computerized system for providing an IP framework, including a storage component, a user interface, and a reporting module. The storage component includes a collection of database tables having a capability field and keyword field. The database tables include data from a strategic planning computer module, an invent computer module, an IP creation computer module, an IP administration computer module, a defend computer module, an influence computer module, and a capitalize computer module.

The strategic planning computer module formulates business strategies for creating and managing inventions and IP rights. This module includes one or more electronic database having data for formulating the business strategies. The data includes market data (e.g., data relating to competitors, customers, products, and services), current and proposed laws and regulations, and IP landscape data (e.g., IP applicants, IP filing data, and IP issuance data).

In one embodiment, the strategic planning computer module includes at least one of seven electronic strategic planning components. A first electronic strategic planning component formulates a strategy to defend against infringements and invalidations of the IP rights; and, a second electronic strategic planning component for formulating a target level of business performance, including meeting needs of customers, providing new products and/or new services, and aligning the business strategies with the marketplace. A third electronic strategic planning component formulates a strategy to acquire IP rights from third parties; and, a fourth electronic strategic planning component formulates a strategy for internal utilization of the IP rights. A fifth electronic strategic planning component identifies potential business opportunities for the inventions and IP rights; and, a sixth electronic strategic planning component identifies potential threats to the business strategies. A seventh electronic strategic planning component directs research and development towards potential business opportunities and potential business threats.

In at least one embodiment, the invent computer module includes at least one of four electronic invent components for managing the creation of inventions based on the business strategies. A first electronic invent component allocates the research and development budget; and, a second electronic invent component sets an invention quantity target and an invention quality target. A third electronic invent component determines whether the invention quantity target and the invention quality target are satisfied; and, a fourth electronic invent component provides inventor training and inventor incentives.

In one embodiment, the IP creation computer module includes at least one of six electronic IP creation components for determining the value of the inventions and creating an IP portfolio, including creating IP rights based on the determined value and the business strategies. A first electronic IP creation component formulates an IP creation target; and, a second electronic IP creation component determines whether the IP creation target is satisfied. A third electronic IP creation component manages outside IP counsel and agents; and, a fourth electronic IP creation component files and prosecutes patent applications, trademark applications, and copyright applications. A fifth electronic IP creation component creates trade secrets; and, a sixth electronic IP creation component measures the performance of the IP rights.

In one embodiment, the IP administration computer module includes at least one electronic IP administration component for managing the IP rights based on the business strategies including extension, maintenance and retirement of the IP rights. This module also measures the performance of the business strategies, creates and modifies budgets, and sets guidelines for IP counsel. A first electronic IP administration component forecasts the performance of the inventions and the IP rights; and, a second electronic IP administration component sets IP policies, including management of the IP portfolio, IP quality, and investment in IP.

In at least one embodiment, the defend computer module includes at least one of seven electronic defend components for defending against infringements and invalidations of the IP rights, based on the business strategies, and for monitoring market and competitor actions to develop risk management plans. A first electronic defend component tracks and reports on revenue-to-product inventory ratios, performance against risk tolerance, and effectiveness of the licensing negotiations, the cross-licensing negotiations, and the assignment negotiations. A second electronic defend component monitors infringement of the IP rights; and, a third electronic defend component conducts legal action against the infringement of the IP rights. A fourth electronic defend component defends IP invalidation proceedings against the IP rights; and, a fifth electronic defend component monitors infringement of IP rights of a third party. A sixth electronic defend component defends against legal action for the infringement of IP rights of a third party; and, a seventh electronic defend component initiates IP invalidation proceedings against the IP rights of a third party.

The influence computer module includes a standards influencing unit, a legal and regulatory influencing unit, and a policy influencing unit. This module includes at least one of five electronic influence components, including a first electronic influence component for determining how current and proposed standards, legal and regulatory decisions, and policies affect the business strategies and the IP rights. A second electronic influence component participates in standards organizations; and, a third electronic influence component lobbies legislative, regulatory and judicial decisions. A fourth electronic influence component prioritizes actions of the second electronic influence component and the third electronic influence component; and, a fifth electronic influence component tracks and reports on the actions of the second electronic influence component and the third electronic influence component.

The capitalize computer module includes at least one of five electronic capitalize components for identifying potential licensees and assignees of the IP rights. This module also manages licensing negotiations, cross-licensing negotiations, and assignment negotiations based on the business strategies. A first electronic capitalize component formulates licensing criteria and policies, including terms and conditions and pricing models; and, a second electronic capitalize component forecasts the performance of licensed IP and modifies the budgets based on the forecasting, the performance of licensed IP including revenue generation, profitability, market share, defensive competitive benefits, and return on investment. A third electronic capitalize component tracks and reports on actual performance of licensed IP. A fourth electronic capitalize component clusters the IP rights into technological groups; and, a fifth electronic capitalize component identifies current strengths and weaknesses in the IP portfolio.

The user interface receives as input, an invention disclosure and/or a configuration file for an IP capability. The reporting module processes the input in the storage component and produces the IP framework.

Another embodiment of the invention provides a method of analyzing a component business model having a plurality of components, wherein each of the components has at least one capability. For each of the components, the method performs the following steps. The method determines whether an organization has the capability from the components, wherein the components are grouped into a strategic planning computer module, an invent computer module, an IP creation computer module, an IP administration computer module, a defend computer module, an influence computer module, and a capitalize computer module.

The strategic planning computer module formulates business strategies for creating and managing inventions and IP rights. The strategic planning module includes at least one electronic database having data for formulating the business strategies. The method identifies at least one strategic planning capability in the strategic planning computer module. In one embodiment, the strategic planning computer module includes seven electronic strategic planning components. A first electronic strategic planning component formulates a strategy to defend against infringements and invalidations of the IP rights. A second electronic strategic planning component formulates a target level of business performance, including meeting needs of customers, providing new products and/or new services, and aligning the business strategies with the marketplace. A third electronic strategic planning component formulates a strategy to acquire IP rights from third parties; and, a fourth electronic strategic planning component formulates a strategy for internal utilization of the IP rights. A fifth electronic strategic planning component identifies potential business opportunities for the inventions and the IP rights; a sixth electronic strategic planning component identifies potential threats to the business strategies; and, a seventh electronic strategic planning component directs research and development towards the potential business opportunities and the potential business threats.

The invent computer module manages creation of the inventions based on the business strategies. The method identifies at least one invent capability in the invent computer module. In one embodiment, the invent computer module has four electronic invent components. A first electronic invent component allocates a research and development budget; and, a second electronic invent component sets an invention quantity target and an invention quality target. A third electronic invent component determines whether the invention quantity target and the invention quality target are satisfied; and, a fourth electronic invent component provides inventor training and inventor incentives.

The IP creation computer module determines the value of the inventions and creates an IP portfolio. This includes creating the IP rights based on the value and the business strategies. The method identifies at least one IP creation capability in the IP creation computer module. In one embodiment, the IP creation computer module has 6 electronic IP creation components. A first electronic IP creation component formulates an IP creation target; and, a second electronic IP creation component determines whether the IP creation target is satisfied. A third electronic IP creation component manages outside IP counsel and agents; and, a fourth electronic IP creation component files and prosecutes patent applications, trademark applications, and copyright applications. A fifth electronic IP creation component creates trade secrets; and, a sixth electronic IP creation component measures the performance of the IP rights.

The IP administration computer module manages the IP rights based on the business strategies including extension, maintenance and retirement of the IP rights, measuring performance of the business strategies, creating and modifying budgets, and setting guidelines for IP counsel. The method identifies at least one IP administration capability in the IP administration computer module. In one embodiment, the IP administration computer module has two electronic IP administration components. A first electronic IP administration component forecasts the performance the inventions and the IP rights; and, a second electronic IP administration component sets IP policies (e.g., management of the IP portfolio, IP quality, and investment in IP).

The defend computer module defends against infringements and invalidations of the IP rights based on the business strategies and monitors market and competitor actions to develop risk management plans. The method identifies at least one defend capability in the defend computer module. In one embodiment, the defend computer module has seven electronic defend components. A first electronic defend component tracks and reports on revenue-to-product inventory ratios, performance against risk tolerance, and effectiveness of the licensing negotiations, the cross-licensing negotiations, and the assignment negotiations. A second electronic defend component monitors infringement of the IP rights; and, a third electronic defend component conducts legal action against the infringement of the IP rights. A fourth electronic defend component defends IP invalidation proceedings against the IP rights; and, a fifth electronic defend component monitors infringement of IP rights of a third party. A sixth electronic defend component defends against legal action for the infringement of IP rights of a third party; and, a seventh electronic defend component initiates IP invalidation proceedings against the IP rights of a third party.

The influence computer module includes a standards influencing unit, a legal and regulatory influencing unit, and a policy influencing unit. The method identifies at least one influence capability in the influence computer module. In one embodiment, the influence computer module has five electronic influence components. A first electronic influence component determines how current and proposed standards, legal and regulatory decisions, and policies affect the business strategies and the IP rights. A second electronic influence component participates in standards organizations; and, a third electronic influence component lobbies legislative, regulatory and judicial decisions. A fourth electronic influence component prioritizes actions of the second electronic influence component and the third electronic influence component. A fifth electronic influence component tracks and reports on the actions of the second electronic influence component and the third electronic influence component.

The capitalize computer module identifies potential licensees and potential assignees of the IP rights, and managing licensing negotiations, cross-licensing negotiations, and assignment negotiations based on the business strategies. The method identifies at least one capitalize capability in the capitalize computer module. In one embodiment, the capitalize computer module has five electronic capitalize components. A first electronic capitalize component formulates licensing criteria and policies, including terms and conditions and pricing models. A second electronic capitalize component forecasts the performance of licensed IP and modifies the budgets based on the forecasting, the performance of licensed IP including revenue generation, profitability, market share, defensive competitive benefits, and return on investment. A third electronic capitalize component tracks and reports on actual performance of the licensed IP; and, a fourth electronic capitalize component clusters the IP rights into technological groups. A fifth electronic capitalize component identifies current strengths and weaknesses in the IP portfolio.

The method determines whether the organization needs the capability, and determines the ability of the organization to deliver the capability. A road map is generated to enable the organization to create and/or improve the capability.

### IV. BRIEF DESCRIPTION OF THE DRAWINGS

The present invention is described with reference to the accompanying drawings. In the drawings, like reference numbers indicate identical or functionally similar elements.

FIGS. 1A-1B illustrates a component business model according to an embodiment of the invention;

FIG. 2 is a flow diagram illustrating a method for utilizing the component business model according to an embodiment of the invention;

FIG. 3 illustrates a system according to an embodiment of the invention;

FIG. 4 illustrates a computerized system for providing an IP framework according to an embodiment of the invention; and

FIG. 5 illustrates a computer program product according to an embodiment of the invention.

### V. DETAILED DESCRIPTION OF THE DRAWINGS

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides client services, including the building, leveraging, and architecting of IP solutions. Methods are provided to assess a client organization's IP stature and provide detailed steps to enable the organization to plan for and to reach higher levels of IP maturity and capability. The methods herein clearly lay out the ingredients or building blocks of a comprehensive IP business architecture, thereby avoiding overlapping and inefficient business systems that typically result when IP solutions are built with the narrow perspective of one single process improvement after another and with no integration across the field.

More specifically, an embodiment of the invention provides a technical framework of IP business process services that may be rendered to a client organization, involving building a map of the capabilities of an IP business operation. An IP Component Business Model (referred to herein as the “CBM”) defines the capabilities that a client organization utilizes in order to effectively manage its IP business. Each capability is a service that the client organization utilizes in order to achieve its IP management mission from invention harvesting to capitalization. The components of the CBM provide the capabilities of the client organization. In other words, the components are the design elements in the CBM; and, the capabilities are the functions of the components. The CBM allows client organizations to operationalize and build cohesive modules around each component and to integrate across multiple components, i.e., have the components work together as an integrated system.

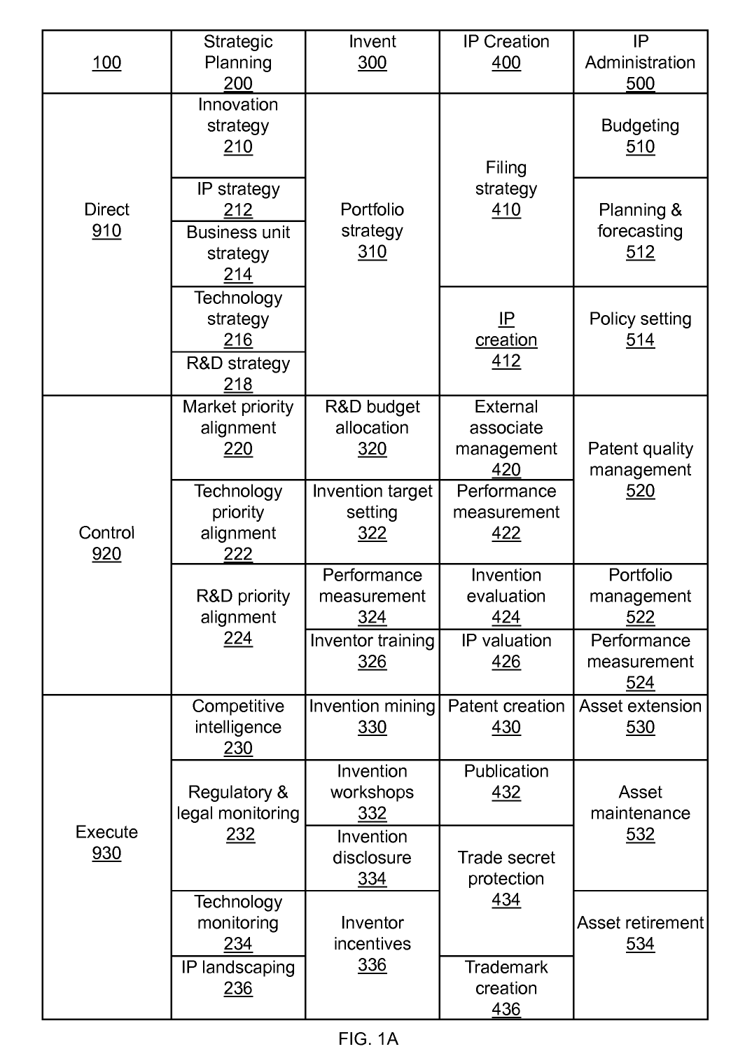

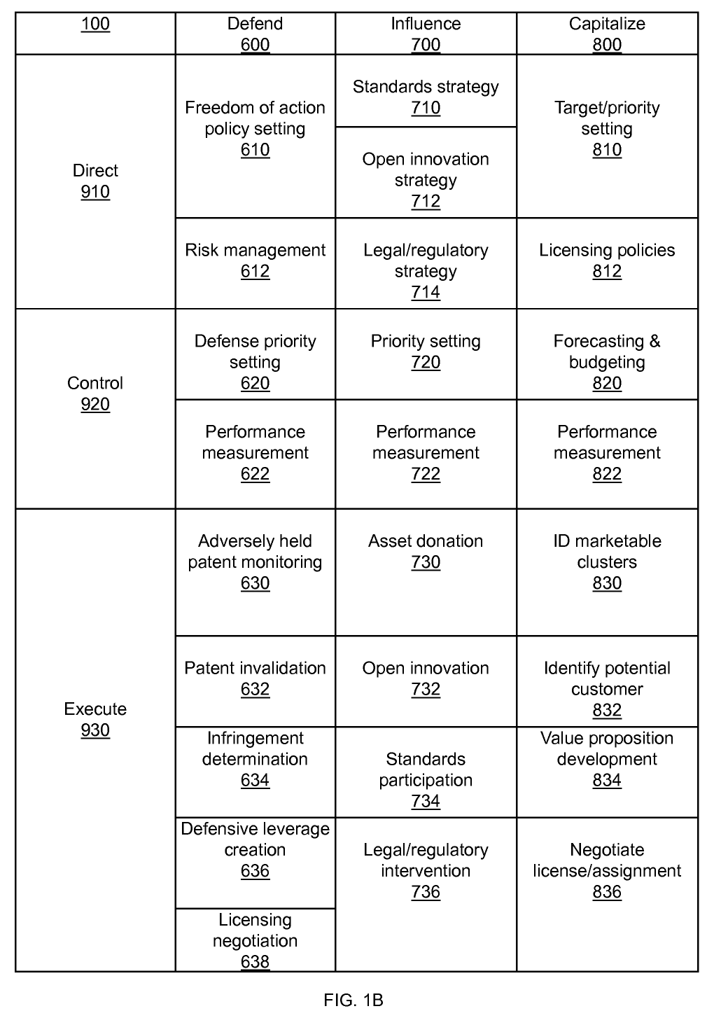

FIGS. 1A-1B illustrate a CBM 100 according to one embodiment of the invention. The CBM 100 includes components 210-836, which are grouped into a Strategic Planning operational process 200, an Invent operational process 300, an IP Creation operational process 400, an IP Administration operational process 500, a Defend operational process 600, an Influence operational process 700, and a Capitalize operational process 800. Within each operational process 200-800, the components 210-836 are further categorized into a Direct operation role, responsibility, and function (ORRF) 910, a Control ORRF 920, or a Execute ORRF 930. Although FIGS. 1A-1B illustrate a CBM 100 having 7 operational processes 200-800 (i.e., columns) and 3 operational roles, responsibilities, and functions 910-930 (i.e., rows), in an alternative embodiment, operational processes and/or operational roles, responsibilities, and functions are added to and/or removed from the CBM 100. For example, in one embodiment, the CBM 100 could lack the Influence operational process 700.

The ORRF's 910-930 define the operational roles, responsibilities, and functions of the system. They are supported by the operational processes 200-800. For example, if an employee has an operational role, responsibility, and function to “direct” a portfolio strategy, then the portfolio strategy component 310 provides the associated processes to support this task, as described more fully below. Each of the components 210-836 includes specific processes, tools, and methodologies to be performed by people for enabling the capabilities of the component. In another example, if a group of employees have an operational role, responsibility, and function to “execute” asset retirement, then the asset retirement component 534 provides the associated processes, people and/or tools to support this task, as described more fully below.

The ability to direct, control and execute allows the components 210-836 and ORRF's 910-930 to function independently, in a defined aggregate, in relationship with one another. Thus, in directing the IP capabilities, a client organization is also able to control and execute for the intended value realization of the IP system and the capabilities defined in the design. For example, if an organizational function is to direct the development of a portfolio strategy (Direct ORRF 910 and component 310), one way that the strategy can be enabled is to control the R&D budget allocation (Control ORRF 920 and component 320) and to execute invention workshops on that strategy (Execute ORRF 930 and component 332), which is funded by the R&D budget allocation component 320. Thus, the portfolio strategy component 310 is interlocked with the innovation strategy component 210, the IP strategy component 212, the business unit strategy component 214, the technology strategy component 216, and the R&D strategy component 218. In this instance, understanding gaps and conflicts enables the strategies to be controlled and executed and redirected as needed.

The components 210-236 in the Strategic Planning operational process 200 provide the capability to plan the client organization's course of action for IP. In order for the organization to work as an integrated whole, multiple strategic areas of the organization are aligned, and information to formulate business strategies is obtained. In at least one embodiment of the invention, the Strategic Planning operational process 200 includes an innovation strategy component 210, an IP strategy component 212, a business unit strategy component 214, a technology strategy component 216, a research and development (R&D) strategy component 218, a market priority alignment component 220, a technology priority alignment component 222, a R&D priority alignment component 224, a competitive intelligence component 230, a regulatory & legal monitoring component 232, a technology monitoring component 234, and an IP landscaping component 236. Although FIG. 1A illustrates that the Strategic Planning operational process 200 includes components 210, 212, 214, 216, 218, 220, 222, 224, 230, 232, 234, and 236, in an alternative embodiment, components are added to and/or removed from the Strategic Planning operational process 200.

In one embodiment, there are clearly defined linkages between the components 210, 212, 214, 216, and 218, which are in the Direct operational role, responsibility, and function 910. The innovation strategy component 210 defines the plan of action a client organization will use to create and enable innovation capabilities for a business advantage. A management system including people, processes, measurements and technology is utilized to support this component. By providing a strategy for innovation, the component 210 enables the emergence of new ideas that are subsequently implemented to create value and provide sustainable growth, efficiency improvements, and advantages in a competitive position.

The IP strategy component 212 defines the plan of action for the client organization, i.e., the actions that the client organization will perform to create, leverage, utilize, and manage IP to succeed against business threats and opportunities. The design and support of an IP management system (i.e., defined roles and responsibilities, processes, technology, and measurements) is utilized to support the IP strategy component 212. The business unit strategy component 214 defines the plan of action a business unit will use to create and enable the desired performance of the business unit (e.g., the client organization). This component identifies how a business unit can successfully compete in a particular market, meet the needs of customers, and provide new products, while creating and exploiting new opportunities for IP that are both offensive and defensive. This provides a means to customize the strategy to be agile in the way it prioritizes and plans according to segment criteria.

The technology strategy component 216 defines the plan of action the client organization will use to develop, acquire, and/or utilize technology to enable business advantage. The plan of action includes productivity and products. Moreover, a business case is provided for decision making, execution, and management capabilities. The technology strategy component 216 includes goals for technology and for the intersections of IP with technology strategies and objectives. The R&D strategy component 218 defines the plan of action that research will undertake to determine threats and opportunities, as well as develop solutions, methodologies, and approaches to address those threats and opportunities. R&D pushes the business strategy to new horizons, identifying new realms for growth and sustained profitability. R&D creates and manages innovation strategies across the business, playing a role in innovation.

In an embodiment of the invention, the components 220, 222, and 224 are in the Control operational role, responsibility, and function 920. By utilizing the processes, people and/or tools of the market priority alignment component 220, the market priorities for the client organization are aligned with the marketplace and the identified threats and opportunities. For example, if the component 220 determines that widgets are desired in the current marketplace, a strategy for selling widgets is formulated. Utilizing input from, for example, the portfolio management component 522 and the business unit strategy component 214, the market priority alignment component 220 determines whether the offerings and IP support the business strategy and objectives and whether the offerings are aligned to the client organization's needs and expectations.

The technology priority alignment component 222 utilizes the processes, people and/or tools of the CBM 100 to align technology priorities with the marketplace and the identified threats and opportunities—both in the development, usage, and discontinuing of technology. The component 222 ensures that technology is an integral element of the business and IP strategies, as well as R&D development and innovation strategy. The R&D priority alignment component 224 also utilizes the processes, people and/or tools of the CBM 100 to align R&D priorities with the marketplace and the identified threats and opportunities of the client organization. The component 224 develops strategically relevant and innovative concepts into products that are aligned with client demand, and discontinues irrelevant concepts and projects as early as possible.

In one embodiment, the components 230, 232, 234, and 236 are in the Execute operational role, responsibility, and function 930. Utilizing the processes, people and/or tools of the CBM 100, the competitive intelligence component 230 defines the capabilities to identify, define, and analyze information about competitors, the market, customers, products, and services. This component uses these capabilities to make the client organization more competitive. The regulatory and legal monitoring component 232 monitors and tracks the development and implementation of laws and regulations that impact the client organization and its IP activities. The component 232 utilizes the processes, people and/or tools of the CBM 100 to ensure that the client organization is acquiring information to make decisions and influence regulatory and legal actions that provide a business advantage.

The technology monitoring component 234 monitors and tracks the development of new technologies and the impact of technology on business actions and activities. This component utilizes the processes, people and/or tools of the CBM 100 to monitor new needs and technical standards that are being applied and determine where influencing technical standards for business advantage are needed. The IP landscaping component 236 provides methodologies for reviewing the current IP landscape in the technology field, in terms of companies, filing velocities, and key patents. By identifying the IP landscape, the component 236 identifies the market segments, and enables the understanding of competitive threats and the identification of potential new technologies and technology providers. This component also guides R&D and IP strategies and investments.

The components 310-336 in the Invent operational process 300 provide the capability to sense and respond to opportunities and threats through leveraging and managing inventions for a business advantage. As described below, this includes portfolio strategies, target setting, and the ability to incent and sustain the skills and capabilities to be utilized. The components 310-336 utilize the processes, people and/or tools of the CBM 100 to ensure that a rich IP portfolio is defined and managed, and that the resources are trained and incented to support the strategy. In at least one embodiment of the invention, the Invent operational process 300 includes a portfolio strategy component 310, an R&D budget allocation strategy component 320, an invention target setting component 322, a performance measurement component 324, an inventor training component 326, an invention mining component 330, an invention workshops component 332, an invention disclosure component 334, and an inventor incentives component 336. Although FIG. 1A illustrates that the Invent operational process 300 includes components 310, 320, 322, 324, 326, 330, 332, 334, and 336, in an alternative embodiment, components are added to and/or removed from the Invent operational process 300.

In one embodiment, the component 310 is in the Direct operational role, responsibility, and function 910. Utilizing the processes, people and/or tools of the CBM 100, the portfolio strategy component 310 defines the plan of action a client organization will use to create, leverage, utilize, and manage a portfolio of IP to succeed against defined business threats and opportunities. This includes new markets, product lines, and licensing strategies and campaigns. The component 310 protects software, processes, methods, and products for a competitive business advantage.

In one embodiment, the components 320, 322, 324, and 326 are in the Control operational role, responsibility, and function 920. Utilizing the processes, people and/or tools of the CBM 100, the R&D budget allocation component 320 provides the policies, processes, procedures, and roles and responsibilities to enable decision making and allocation of R&D funding for the IP priorities defined by the client organization. This component ensures that funds are made available and that the priorities for R&D and IP are in alignment. The invention target setting component 322 utilizes the processes, people and/or tools of the CBM 100 to define the inventions (and corresponding IP) that will enable the client organization to effectively compete. This includes managing risks and capitalizing on defined opportunities. Invention target setting further includes a defined number of inventions and the quality of inventions.

The performance measurement component 324 provides the metrics, policies, processes, procedures, and roles and responsibilities utilized to track and generate reports on the performance of the IP Portfolio and the inventions. Thus, the appropriate reports on portfolio gaps and the competitive effectiveness of the portfolio and the inventions are generated. Because the components 210-836 are interconnected, these reports are linked back to decision making on the portfolio strategy, invention target setting, training, and incentive needs. The inventor training component 326 provides the training plans and training content to enable inventor capabilities and skills. The training plans and content includes the understanding and utilization of the IP management system (e.g., policies, processes, procedures, roles and responsibilities, and metrics) to enable IP creation and management. By providing inventor training plans and training content, the component 326 enables the understanding of the IP and the incentives available for the inventors, and supports the cultural objectives required to enable and sustain the capability.

In one embodiment, the components 330, 332, 334, and 336 are in the Execute operational role, responsibility, and function 930. The invention mining component 330 ensures that the client organization has the ability to mine the organization for inventions and harvest the inventions for a business advantage. This component defines the invention mining capabilities (e.g., policies, processes, procedures, roles and responsibilities, and metrics) to enable the invention objectives. The invention workshops component 332 defines events where structured processes and methodologies are utilized to develop skills. Such events capture, evaluate, and transform ideas into meaningful inventions. Invention workshops work in alignment with innovation and IP business objectives. The events focus on new ideas around emerging technologies, and scanning for potential applications and areas to protect and exploit. The output can also be input to strategic planning operational process 200 and may create new strategies.

The invention disclosure component 334 defines the process, policies, tools, and roles and responsibilities for capturing, reviewing, and managing the invention disclosure and decision making for inventions. This component focuses on the capabilities of reducing IP flight, increasing IP quality, and managing IP quality. The inventor incentives component 336 defines the process, policies, tools, roles and responsibilities, and programs for rewarding and recognizing invention contributions to the client organization. Inventor incentives are linked to the budget and human resource processes. This component also supports the strategy and culture.

The components 410-436 in the IP Creation operational process 400 provide the capability to create, value, and protect IP for a business advantage. This is based on the defined needs of the business and on the legally defined areas of patent, trademark, trade secret, and copyright. The IP Creation operational process protects the client organization against IP leakage. In at least one embodiment of the invention, the IP Creation operational process 400 includes a filing strategy component 410, an IP creation target setting component 412, an external associate management component 420, a performance measurement component 422, an invention evaluation component 424, an IP valuation component 426, a patent creation component 430, a publication component 432, a trade secret component 434, and a trademark creation component 436. Although FIG. 1A illustrates that the IP Creation operational process 400 includes components 410, 412, 420, 422, 424, 426, 430, 432, 434, and 436, in an alternative embodiment, components are added to and/or removed from the IP Creation operational process 400.

In one embodiment, the components 410 and 412 are in the Direct operation role, responsibility, and function 910. The filing strategy component 410 defines the plan of action a client organization will use to file for patent protection that supports the IP portfolio strategy and the IP strategy. The filing strategy enables the client organization and the inventors to create and protect IP to succeed against defined business threats and opportunities, including new markets, product lines, and licensing strategies and campaigns. The IP creation component 412 identifies the IP to support the IP strategy 212 and the IP portfolio strategy 310. Once the IP identified by the component 412 is created, the client organization is able to perform as defined by the IP strategy 212 and the IP portfolio strategy 310. This ensures that disciplines and expertise are applied to enable the creation of IP. The component 412 includes defined domains, specific types, and numbers needed.

In one embodiment, the components 420, 422, 424, and 426 are in the Control operation role, responsibility, and function 920. The external associate management component 420 defines the policies, practices, and procedures for managing external counsel and agents to support the IP strategy and portfolio strategy. This component includes funding and cost control measures. The performance measurement component 422 defines the metrics, policies, processes, procedures, and roles and responsibilities to track and report on the performance of the IP, as well as the inventors and the invention sessions.

The invention evaluation component 424 defines the process and criteria for decision making on an invention. An IP decision tree provides guidance on the “go forward” plan for the invention, e.g., whether to patent, publish, trade secret, or trademark the invention. Invention evaluation leverages domain subject matter expertise. The IP valuation component 426 defines the process, criteria, and weighting factors for decision making on an invention. The weighting factors are applied to the IP to enable valuation and to provide input on how to leverage and manage the invention for business advantage. The component 426 vets IP that is high quality and of high value. This component also feeds into performance measurements that are tracked and reported. Invention evaluation leverages domain subject matter expertise.

In one embodiment, the components 430, 432, 434, and 436 are in the Execute operation role, responsibility, and function 930. The patent creation component 430 defines the process for enabling the client organization to develop and protect inventions that are new, useful, and non-obvious. This excludes others from making, using, or selling the patented invention for a limited time in exchange for disclosing the invention to the public. The component 430 ensures that skills and a decision process to define, protect, and manage are operational, and that patent quality is embedded in the process. The publication component 432 defines the process, policies, procedures, and roles and responsibilities to protect the particular expression of an idea against copying. This ensures that skills and a decision process to define, protect, and manage are operational and are in alignment with the strategic intent and direction.

The trade secret protection component 434 defines the process, policies, procedures, and roles and responsibilities to protect the client organization and the technical information for economic advantage. This ensures that trade secrets are properly maintained as secret and that skills and a decision process to define, protect and manage are operational. The trademark creation component 436 defines the process, policies, procedures, roles and responsibilities, skills, and funding to enable the creation and protection of trademarks. Skills include the understanding of the value of trademarks and what they mean to the client organization and the IP strategy. This ensures that trademarks are registered and properly protected.

The components 510-534 in the IP Administration operational process 500 provide the capability to support the IP function (e.g., budgeting, policies, processes, procedures, roles and responsibilities, and defined performance metrics) utilized by the IP system to enable execution of the IP strategies and the performance of IP capabilities defined by the client organization. In at least one embodiment, the IP Administration operational process 500 includes a budgeting component 510, a planning & forecasting component 512, a policy setting component 514, a patent quality management component 520, a portfolio budgeting component 522, a performance measurement component 524, an asset extension component 530, an asset maintenance component 532, and an asset retirement component 534. Although FIG. 1A illustrates that the IP Administration operational process 500 includes components 510, 512, 514, 520, 522, 524, 530, 532, and 534, in an alternative embodiment, components are added to and/or removed from the IP Administration operational process 500.

In one embodiment, the components 510, 512, and 514 are in the Direct operation role, responsibility, and function 910. The budgeting component 510 defines the policies, processes, procedures, and roles and responsibilities to enable decision making and allocate funding for IP priorities, including IP strategy, strategy execution, and an IP management system. The planning & forecasting component 512 defines the policies, processes, procedures, and roles and responsibilities to plan and forecast the expected outcome and performance of IP activities, including guidance and input from the business unit and corporate strategy. The policy setting component 514 defines the process and roles and responsibilities for developing the IP policies to support the IP capabilities utilized by the client organization. Policies include portfolio management, patent quality, and asset management, e.g., extensions, maintenance, retirement, budgeting, measurement, and investment. This includes guidelines for outside counsel.

In one embodiment, the components 520, 522, and 524 are in the Control operation role, responsibility, and function 920. The patent quality management component 520 defines the criteria, policies, processes, procedures, and roles and responsibilities for managing the quality of patents. This includes patent objectives and standards that are defined by the client organization and skills that are defined and developed to enable patent quality management (PQM). The portfolio budgeting component 522 defines the policies, processes, procedures, and roles and responsibilities to enable decision making and allocate funding for the defined IP portfolio. The performance measurement component 524 provides the defined metrics, policies, processes, procedures, and roles and responsibilities to track and report on the performance of the IP strategy and return on investment for the prioritized IP activities, e.g., new product lines, new markets, and licensing campaigns.

In one embodiment, the components 530, 532, and 534 are in the Execute operation role, responsibility, and function 930. The asset extension component 530 provides the defined policies, processes, procedures, and roles and responsibilities to identify and manage assets so they can be leveraged for higher business value.

The asset maintenance component 532 defines the policies, processes, procedures, and roles and responsibilities to identify and manage assets so they can be refreshed and sustained for a greater business advantage. The component 532 also ensures that the assets can perform as planned and forecasted. This ensures that the assets are managed from creation to discontinuation. This also ensures that adequate investments and asset business case management are applied and are providing desired business results. The asset retirement component 534 defines the criteria, policies, processes, procedures, and roles and responsibilities to identify assets for retirement. Assets are retired (i.e., discontinued) to reduce the risk of inefficient use of funds.

The components 600-638 in the Defend operational process 600 provide the capability to protect and defend against infringements and invalidations of patents, as well as the capability to negotiate licenses for business advantage and cross licenses for business benefit. This ensures that the client organization is utilizing legal advice, expertise, and strategies to protect its IP interests and is monitoring market and competitor actions to develop risk management approaches and plans. In at least one embodiment, the Defend operational process 600 includes a freedom of action policy setting component 610, a risk management component 612, a defense priority setting component 620, a performance measurement component 622, an adversely held patent monitoring component 630, a patent invalidation component 632, an infringement determination component 634, a defensive leverage creation component 636, and a licensing negotiation component 638. Although FIG. 1B illustrates that the Defend operational process 600 includes components 610, 612, 620, 622, 630, 632, 634, 636, and 638, in an alternative embodiment, components are added to and/or removed from the Defend operational process 600.

In one embodiment, the components 610 and 612 are in the Direct operation role, responsibility, and function 910. The freedom of action policy setting component 610 defines the criteria for and policies, processes, and procedures for the development of the IP policies that enable the client organization to leverage between offensive and defensive strategies. Having an understanding of offensive and defensive strategies enables IP to be leveraged in cross-licensing agreements as desired by the client organization for business advantage. The risk management component 612 defines the criteria for and policies, processes, and procedures for managing business risk associated with IP. This includes defined risk tolerance and mechanisms to enable the client organization to manage litigation and litigation threats.

In one embodiment, the components 620 and 622 are in the Control operation role, responsibility, and function 920. The defense priority setting component 620 defines the decision processes and plan of action to ensure that IP is protected and cannot be exploited by others. This component also ensures that the acquisition strategies for IP are designed and utilized to prevent others from gaining a competitive advantage and unfair usage of IP owned by the client organization and by others. The performance measurement component 622 provides the defined metrics, policies, processes, procedures, and roles and responsibilities to track and report on patent litigation, revenue to product inventory ratio, performance against risk tolerance, and effectiveness of licensing negotiations. Performance measurements ensure that the portfolio strategy supports freedom of action.

In one embodiment, the components 630, 632, 634, 636, and 638 are in the Execute operation role, responsibility, and function 930. The adversely held patent monitoring component 630 provides the defined processes, policies, procedures, and roles and responsibilities for identifying and managing adversely held patents. This ensures that the client organization is monitoring whether its new products and offerings will infringe the patent rights of others. The component 630 focuses on minimizing risk and damages in the event that there is an infringement. This component utilizes legal expertise to research and monitor adversely held patents.

The patent invalidation component 632 defines the policies, processes, procedures, and roles and responsibilities to conduct patent invalidations and defend against patent invalidations. This includes double patenting rejections and amendments filed with the Patent Office that go beyond the scope of a patent application's originally filed claims. The infringement determination component 634 defines the policies, processes, procedures, and roles and responsibilities to conduct reviews and determine the occurrence of infringement. This ensures that the client organization is monitoring whether others are infringing on their patent rights.

The defensive leverage creation component 636 defines the decision process and plan of action to identify, create, and protect IP for defensive purposes. The decision process includes whether to patent for purposes of leveraging against lawsuits for infringement or as a negotiating tool to be able to use another's patent. The decision process also includes the usage of “patent pools” to avoid lawsuits. Patent pools utilize legal expertise to draft agreements that avoid violating antitrust laws, while enabling groups of patent owners to pool their patents to make products in exchange for agreements to license those patents together to others or not to sue each other for infringement if they license independently. The licensing negotiation component 638 defines the policies, processes, procedures, and roles and responsibilities for managing license negotiations and leveraging the best practices in the negotiation process. This capability ensures that the IP is valued for business advantage and that actions are taken to exploit that value.

The components 710-736 in the Influence operational process 700 provide the capability to influence standards, legal and regulatory decisions, and policies. As described below, this enables innovation across the enterprise and ensures the effective usage of standards for business advantage, including the sharing, protecting, and leveraging of IP. In at least one embodiment, the Influence operational process 700 includes a standards strategy component 710, an open innovation strategy component 712, a legal/regulatory strategy component 714, a priority setting component 720, a performance measurement component 722, an asset donation component 730, an open innovation component 732, a standards participation component 734, and a legal/regulatory intervention component 736. Although FIG. 1B illustrates that the Influence operational process 700 includes components 710, 712, 714, 720, 722, 730, 732, 734, and 736, in an alternative embodiment, components are added to and/or removed from the Influence operational process 700.

In one embodiment, the components 710, 712, and 714 are in the Direct operation role, responsibility, and function 910. The standards strategy component 710 defines the plan of action that the client organization will use to define the value and benefits of standards, and how they will be applied to the business and IP strategies. The standards strategy includes industry and IP standards, as well as participation in standards organizations—both applying and adhering to standards and influencing the development of standards for business advantage.

The open innovation strategy component 712 defines the plan of action the client organization will use to develop an open innovation strategy. The open innovation strategy defines the people, process, and technology components utilized, including culture and behavior. The open innovation strategy intersects and is aligned with the IP strategy, technology strategy, R&D strategy, and business unit strategy. An innovation management system is utilized to support the open innovation strategy. The legal/regulatory strategy component 714 defines the plan of action the business organization will use to drive lobbying activities and defined actions and priority areas to influence legislative, regulatory, and judicial decisions for business benefit.

In one embodiment, the components 720 and 722 are in the Control operation role, responsibility, and function 920. The priority setting component 720 defines the processes and approach to identify a prioritized set of actions to ensure that the client organization is able to participate in and influence industry and IP standards, as well as legal and regulatory policies and decisions. This includes leveraging the actions of standards organizations and boards, legal and regulatory bodies, and innovation agendas for a business advantage. This ensures the linkage between funding, resource needs, performance metrics, and business strategies are in alignment and co-operational. The performance measurement component 722 defines the metrics that track and report on the success of influence campaigns. This includes standards strategy, open innovation strategy, legal/regulatory strategy, asset donation, standards participation, and legal and regulatory intervention.

In one embodiment, the components 730, 732, 734, and 736 are in the Execute operation role, responsibility, and function 930. The asset donation component 730 defines the policies, processes, procedures, and roles and responsibilities for decision making on asset donation for a business advantage. The decision process includes defining the value of the donation (e.g., the defensive and offensive value) and defining the domain areas where assets will be donated. The open innovation component 732 defines the ability to innovate across the enterprise and engage broad participation with the innovation strategy component 210 and the IP strategy component 212, among other processes. Tools, processes, policies, and procedures for open innovation are developed and deployed. Collaboration activities are prevalent and operationalize processes; and, innovation supports IP development.

The standards participation component 734 provides the defined plan of action for participation in standards boards and the creation and co-creation of standards that benefit the business strategy and objectives. Funding and designated resources are allocated and utilized. The legal/regulatory intervention component 736 provides the ability to engage and the actions to influence legal and regulatory processes and decision makers in decisions that support the desired current state and that impact the desired end state and needs of the client organization.

The components 810-836 in the Capitalize operational process 800 provide the capability to leverage and exploit IP for business advantage. This includes licensing to generate financial benefits and to inhibit competitor encroachment. In at least one embodiment, the Capitalize operational process 800 includes a target/priority setting component 810, a licensing policies component 812, a forecasting & budgeting component 820, a performance measurement component 822, an ID marketable clusters component 830, an identify potential customers component 832, a value proposition development component 834, and a negotiate license/assignment component 836. Although FIG. 1B illustrates that the Capitalize operational process 800 includes components 810, 812, 820, 822, 830, 832, 834, and 836, in an alternative embodiment, components are added to and/or removed from the Capitalize operational process 800.

In one embodiment, the components 810 and 812 are in the Direct operation role, responsibility, and function 910. The target priority setting component 810 defines the processes, actions, and approach to identify a prioritized set of opportunities for leveraging IP for business advantage. Having identified the prioritized set of opportunities, the component 810 enables strategic use of IP, including generating financial benefits (revenue/income), moving into new markets, technologies, and partnerships. These actions are in alignment with the business priorities and objectives and will support and enable the business strategy to be executed. Decisions on the prioritized opportunities ensure that the business and IP strategies are working in partnership to achieve common objectives. The licensing policies component 812 defines the licensing criteria and policies to enable the client organization to leverage and exploit IP for a business advantage. This includes offensive and defensive strategies and mechanisms to define policies, terms and conditions, and pricing models.

In one embodiment, the components 820 and 822 are in the Control operation role, responsibility, and function 920. The forecasting & budgeting component 820 defines the policies, processes, procedures, and roles and responsibilities to forecast the expected outcome and performance of the licensed IP and to define and allocate the budget needed to support and maintain the IP. This includes guidance and input from the business unit and corporate strategy. The expected outcomes include income and revenue generation, profitability, market share, and defensive competitive benefits. The performance measurement component 822 provides the defined metrics, policies, processes, procedures, and roles and responsibilities to track and report on the performance of the licensed IP. This includes revenue generation, profitability, market share, defensive competitive benefits, competitor benchmarks, and return on investment.

In one embodiment, the components 830, 832, 834, and 836 are in the Execute operation role, responsibility, and function 930. The identify (ID) marketable clusters component 830 defines the process, roles and responsibilities, and tools for identifying and clustering IP—for example, into technological groups for ease of management and leveraging for an economic advantage. The component 830 focuses on the analytical and technical skills, approaches, and processes to identify patent clusters. Benefits include supporting decision making on opportunities to partner and moving into new business areas. This provides a greater understanding of current strengths and weaknesses of the IP portfolio, including where investments should be made. The identify potential customers component 832 defines the processes, tools, and roles and responsibilities to identify and analyze customers. Customers and customer segments are defined that are most likely to have a need for the IP and the funding to license the IP.

The value proposition development component 834 defines the program, resources, and intelligence to identify, document, and develop the IP value proposition. This includes functionality, user experience, cost to market, time to market, reliability, and performance benefits against tasks, competitors, and business objectives. The negotiate license/assignment component 836 defines the policies, processes, procedures, and roles and responsibilities to manage license negotiations and to convey IP through the assignment of rights. This ensures that the license negotiations and assignments for IP are planned and executed for an optimum business advantage. The component 836 also ensures that the best practices and skills are leveraged in the negotiation and assignment processes.

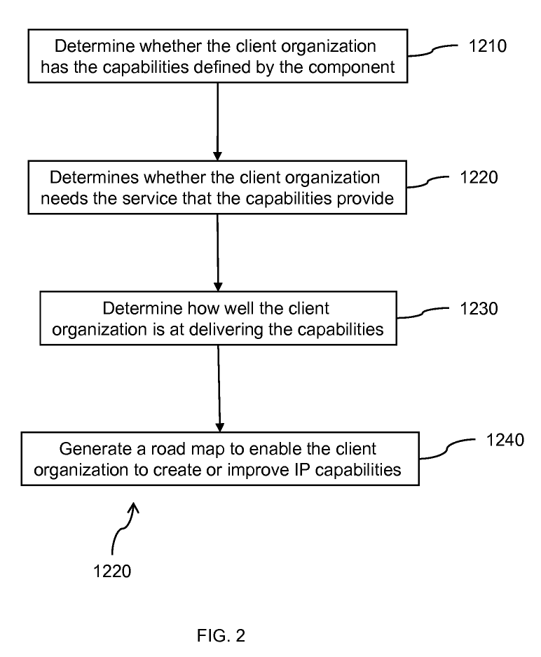

The IP management process is made explicit in a way that enables evaluation by methodologies utilizing the CBM 100. FIG. 2 illustrates a method 1200 for utilizing the CBM 100 according to an embodiment of the invention. For each component 210-836, the method 1200 analyzes the capabilities defined by the individual component. More specifically, the method 1200 determines whether the client organization has the capabilities defined by the component (item 1210). For example, the negotiate license/assignment component 836 provides multiple capabilities, including the capability to manage licensing negotiations. The method 1200 determines whether the client organization has the capability to manage the negotiations and manage it at the desired level needed.

For each component 210-836, the method 1200 also determines whether the client organization needs the service that the capabilities provide (1220). Thus, for the negotiate license/assignment component 836, the method 1200 determines whether the client organization needs the capability to manage licensing negotiations. Furthermore, for each component 210-836, the method 1200 determines how well the client organization is at delivering the capabilities (1230). For instance, for the negotiate license/assignment component 836, the method 1200 determines how effective, or ineffective, the client organization is at managing licensing negotiations. Based on the analysis performed in items 1210, 1220, and 1230, the method 1200 generates a road map to enable the client organization to create or improve IP capabilities (1240).

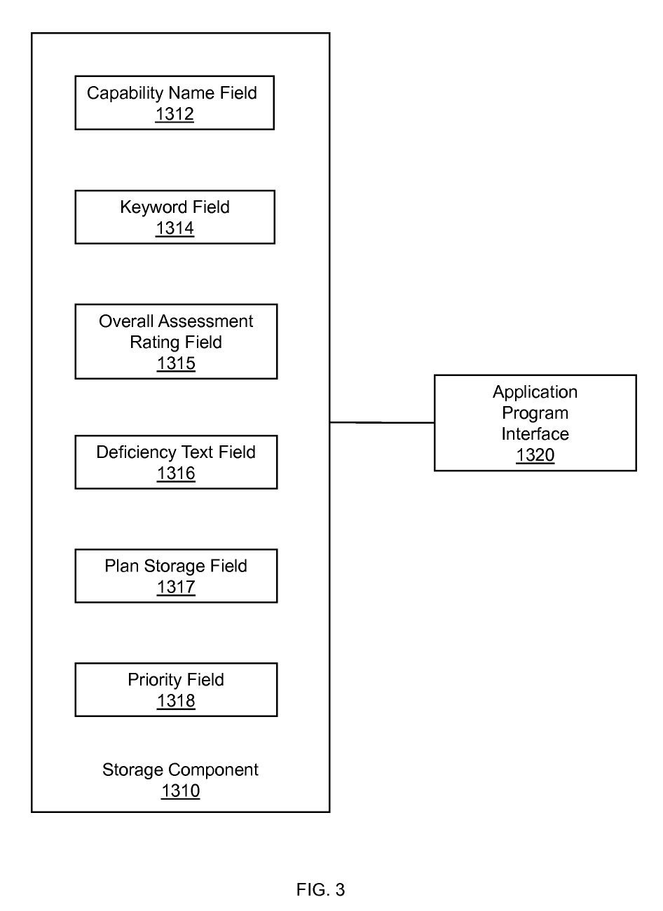

FIG. 3 illustrates a system 1300 according to an embodiment of the invention, including a storage component 1310 and an application programming interface (API) 1320. The storage component 1310 provides a collection of database tables (or other data repository) containing multiple fields. Each database table represents a single client organization. At least one embodiment of the invention provides a Capability Name field 1312 and one or more Keyword fields 1314, wherein each Capability Name field 1312 and Keyword field 1314 maps to one of the components 210-836 in the CBM 100. The Keyword fields 1314 describe the capabilities in the CBM 100 for automated searching of the storage component 1310.

The storage component 1310 also includes other fields, such as, for exemplary purposes only, an Overall Assessment Rating field 1315 (e.g., numeric or other status), a Deficiency Text field 1316, a Plan Storage field 1317 (e.g., attachments), and a Priority field 1318.

The storage component 1310 facilitates the storage and retrieval of information, and includes nonvolatile storage, e.g., a hard disk drive and/or a flash drive. A query component 1319 is provided as an interface between software programs and physical storage. In one embodiment, the query component 1319 includes a relational database, e.g., DB2 (available from International Business Machines, Armonk, N.Y., USA).

The API 1320 enables each invention disclosure mapped to the CBM 100 to use the entire CBM 100 according to their needs. The API 1320 has the ability to determine the IP capabilities that are included in the CBM 100. Moreover, the API 1320 applies status coloring and interacts with the storage component 1310.

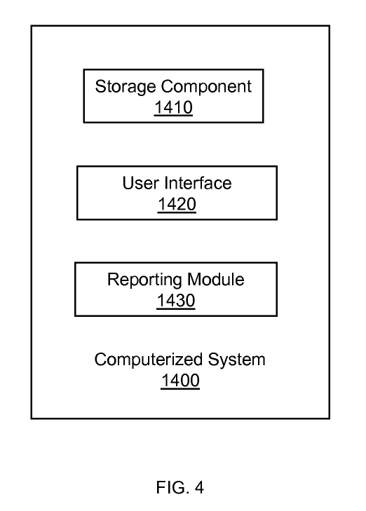

FIG. 4 illustrates a computerized system 1400 for providing an IP framework according to an embodiment of the invention. The system 1400 includes a storage component 1410, a user interface 1420, and a reporting module 1430. The storage component 1410 includes a collection of database tables having a capability field and keyword field. The database tables include data from the strategic planning computer module 200, invent computer module 300, IP creation computer module 400, IP administration computer module 500, defend computer module 600, influence computer module 700, and capitalize computer module 800.

As described more fully above, the strategic planning computer module 200 formulates business strategies for creating and managing inventions and IP rights. This module includes one or more electronic database having data for formulating the business strategies. The data includes market data (e.g., data relating to competitors, customers, products, and services), current and proposed laws and regulations, and IP landscape data (e.g., IP applicants, IP filing data, and IP issuance data). The invent computer module 300 manages the creation of inventions based on the business strategies; and, the IP creation computer module 400 determines the value of the inventions and creates an IP portfolio, including creating IP rights based on the determined value and the business strategies. The IP administration computer module 500 manages the IP rights based on the business strategies including extension, maintenance and retirement of the IP rights. This module also measures the performance of the business strategies, creates and modifies budgets, and sets guidelines for IP counsel. The defend computer module 600 defends against infringements and invalidations of the IP rights, based on the business strategies, and monitors market and competitor actions to develop risk management plans. The influence computer module 700 includes a standards influencing unit, a legal and regulatory influencing unit, and a policy influencing unit. The capitalize computer module 800 identifies potential licensees and assignees of the IP rights. This module also manages licensing negotiations, cross-licensing negotiations, and assignment negotiations based on the business strategies. The user interface 1420 receives as input, an invention disclosure and/or a configuration file for an IP capability. The reporting module 1430 processes the input in the storage component 1410 and produces the IP framework.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

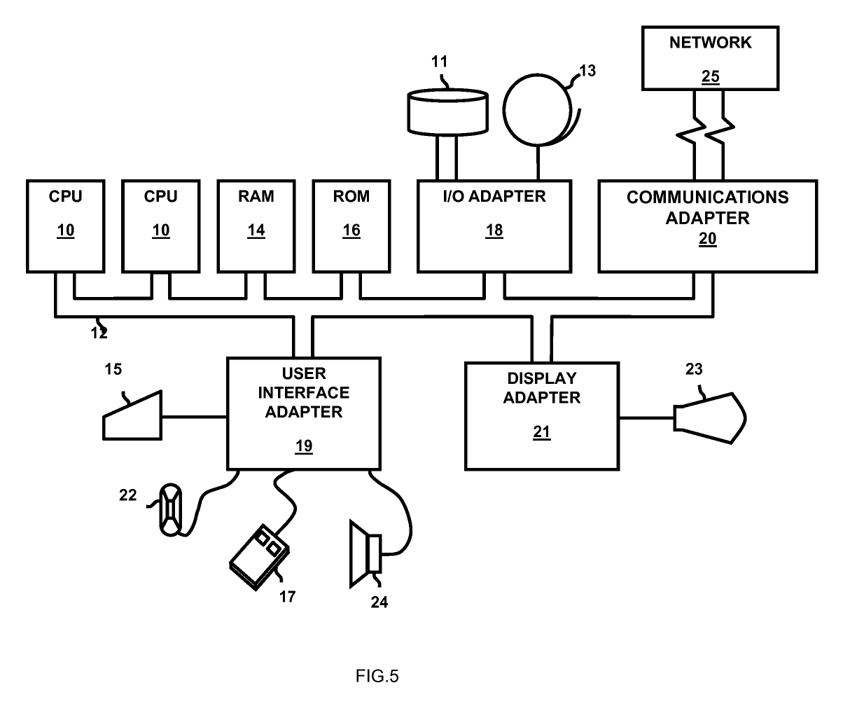

Referring now to FIG. 5, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A computerized system for an intellectual property (IP) framework, including:
a strategic planning computer module for formulating business strategies for creating and managing inventions and IP rights, said strategic planning module including at least one electronic database having data for formulating said business strategies;
an invent computer module for managing creation of said inventions based on said business strategies;
an IP creation computer module for determining value of said inventions and creating an IP portfolio, said creating of said IP portfolio including creating said IP rights based on said determining of said value and said business strategies;
an IP administration computer module for managing said IP rights based on said business strategies including extension, maintenance and retirement of said IP rights, measuring performance of said business strategies, creating and modifying budgets, and setting guidelines for IP counsel;
a defend computer module for defending against infringements and invalidations of said IP rights based on said business strategies and monitoring market and competitor actions to develop risk management plans;
an influence computer module including a standards influencing unit, a legal and regulatory influencing unit, and a policy influencing unit; and
a capitalize computer module for identifying potential licensees and potential assignees of said IP rights, and managing licensing negotiations, cross-licensing negotiations, and assignment negotiations based on said business strategies,
said business strategies provided by said strategic planning computer module being input into at least one of said invent computer module, said IP creation computer module, said IP administration computer module, said defend computer module, said influence computer module, and said capitalize computer module,
said inventions provided by said invent computer module being input into said IP creation computer module, and
said IP rights provided by said IP creation computer module being input into at least one of said IP administration computer module, said defend computer module, said influence computer module, and said capitalize computer module.

2. The computerized system according to claim 1, wherein said strategic planning computer module includes at least one of:
a first electronic strategic planning component for formulating a strategy to defend against said infringements and invalidations of said IP rights;
a second electronic strategic planning component for formulating a target level of business performance, said business performance including meeting needs of customers, providing at least one of new products and new services, and aligning said business strategies with the marketplace;
a third electronic strategic planning component for formulating a strategy to acquire IP rights from third parties;
a fourth electronic strategic planning component for formulating a strategy for internal utilization of said IP rights;
a fifth electronic strategic planning component for identifying potential business opportunities for said inventions and said IP rights;
a sixth electronic strategic planning component for identifying potential threats to said business strategies; and
a seventh electronic strategic planning component for directing said research and development towards said potential business opportunities and said potential business threats.

3. The computerized system according to claim 1, wherein said data in said electronic database includes at least one of: market data including data relating to competitors, customers, products, and services; current and proposed laws and regulations; and IP landscape data including IP applicants, IP filing data, and IP issuance data.

4. The computerized system according to claim 1, wherein said invent computer module includes at least one of:
a first electronic invent component for allocating a research and development budget;
a second electronic invent component for setting an invention quantity target and an invention quality target;
a third electronic invent component for determining whether said invention quantity target and said invention quality target are satisfied; and
a fourth electronic invent component for inventor training and inventor incentives.

5. The computerized system according to claim 1, wherein said IP creation computer module includes at least one of:
a first electronic IP creation component for formulating an IP creation target;
a second electronic IP creation component for determining whether said IP creation target is satisfied;
a third electronic IP creation component for managing outside IP counsel and agents;
a fourth electronic IP creation component for filing and prosecuting patent applications, trademark applications, and copyright applications;
a fifth electronic IP creation component for creating trade secrets; and
a sixth electronic IP creation component for measuring a performance of said IP rights.

6. The computerized system according to claim 1, wherein said IP administration computer module includes at least one of:
a first electronic IP administration component for forecasting a performance said inventions and said IP rights; and
a second electronic IP administration component for setting IP policies, said IP policies including management of said IP portfolio, IP quality, and investment in IP.

7. The computerized system according to claim 1, wherein said defend computer module includes at least one of:
a first electronic defend component for tracking and reporting on revenue-to-product inventory ratios, performance against risk tolerance, and effectiveness of said licensing negotiations, said cross-licensing negotiations, and said assignment negotiations;
a second electronic defend component for monitoring infringement of said IP rights;
a third electronic defend component for conducting legal action against said infringement of said IP rights;
a fourth electronic defend component for defending IP invalidation proceedings against said IP rights;
a fifth electronic defend component for monitoring infringement of IP rights of a third party;
a sixth electronic defend component for defending against legal action for said infringement of IP rights of a third party; and
a seventh electronic defend component for initiating IP invalidation proceedings against said IP rights of a third party.

8. The computerized system according to claim 1, wherein said influence computer module includes at least one of:
a first electronic influence component for determining how current and proposed standards, legal and regulatory decisions, and policies affect said business strategies and said IP rights;
a second electronic influence component for participating in standards organizations;
a third electronic influence component for lobbying legislative, regulatory and judicial decisions;
a fourth electronic influence component for prioritizing actions of said second electronic influence component and said third electronic influence component; and
a fifth electronic influence component for tracking and reporting on said actions of said second electronic influence component and said third electronic influence component.

9. The computerized system according to claim 1, wherein said capitalize computer module includes at least one of:
a first electronic capitalize component for formulating licensing criteria and policies, including terms and conditions and pricing models;
a second electronic capitalize component for forecasting a performance of licensed IP and modifying said budgets based on said forecasting, said performance of licensed IP including revenue generation, profitability, market share, defensive competitive benefits, and return on investment;
a third electronic capitalize component for tracking and reporting on actual performance of licensed IP;
a fourth electronic capitalize component for clustering said IP rights into technological groups; and
a fifth electronic capitalize component for identifying current strengths and weaknesses in said IP portfolio.

10. A computerized system for providing an intellectual property (IP) framework, including:
a storage component including a collection of database tables configured to include a capability field and keyword field, said collection of database tables including data from
a strategic planning computer module for formulating business strategies for creating and managing inventions and IP rights, said strategic planning module including at least one electronic database having data for formulating said business strategies,
an invent computer module for managing creation of said inventions based on said business strategies,
an IP creation computer module for determining value of said inventions and creating an IP portfolio, said creating of said IP portfolio including creating said IP rights based on said determining of said value and said business strategies,
an IP administration computer module for managing said IP rights based on said business strategies including extension, maintenance and retirement of said IP rights, measuring performance of said business strategies, creating and modifying budgets, and setting guidelines for IP counsel,
a defend computer module for defending against infringements and invalidations of said IP rights based on said business strategies and monitoring market and competitor actions to develop risk management plans,
an influence computer module including a standards influencing unit, a legal and regulatory influencing unit, and a policy influencing unit, and
a capitalize computer module for identifying potential licensees and potential assignees of said IP rights, and managing licensing negotiations, cross-licensing negotiations, and assignment negotiations based on said business strategies;
a user interface for receiving input, said input including at least one of an invention disclosure and a configuration file for an IP capability; and
a reporting module for processing said input in said storage component and producing said IP framework.

11. The computerized system according to claim 10, wherein said strategic planning computer module includes at least one of:
a first electronic strategic planning component for formulating a strategy to defend against said infringements and invalidations of said IP rights;
a second electronic strategic planning component for formulating a target level of business performance, said business performance including meeting needs of customers, providing at least one of new products and new services, and aligning said business strategies with the marketplace;
a third electronic strategic planning component for formulating a strategy to acquire IP rights from third parties;
a fourth electronic strategic planning component for formulating a strategy for internal utilization of said IP rights;
a fifth electronic strategic planning component for identifying potential business opportunities for said inventions and said IP rights;
a sixth electronic strategic planning component for identifying potential threats to said business strategies; and
a seventh electronic strategic planning component for directing said research and development towards said potential business opportunities and said potential business threats.

12. The computerized system according to claim 10, wherein said invent computer module includes at least one of:
a first electronic invent component for allocating a research and development budget;
a second electronic invent component for setting an invention quantity target and an invention quality target;
a third electronic invent component for determining whether said invention quantity target and said invention quality target are satisfied; and
a fourth electronic invent component for inventor training and inventor incentives.

13. The computerized system according to claim 10, wherein said IP creation computer module includes at least one of:
a first electronic IP creation component for formulating an IP creation target;
a second electronic IP creation component for determining whether said IP creation target is satisfied;
a third electronic IP creation component for managing outside IP counsel and agents;
a fourth electronic IP creation component for filing and prosecuting patent applications, trademark applications, and copyright applications;
a fifth electronic IP creation component for creating trade secrets; and
a sixth electronic IP creation component for measuring a performance of said IP rights.

14. The computerized system according to claim 10, wherein said IP administration computer module includes at least one of:
a first electronic IP administration component for forecasting a performance said inventions and said IP rights; and
a second electronic IP administration component for setting IP policies, said IP policies including management of said IP portfolio, IP quality, and investment in IP.

15. The computerized system according to claim 10, wherein said defend computer module includes at least one of:
a first electronic defend component for tracking and reporting on revenue-to-product inventory ratios, performance against risk tolerance, and effectiveness of said licensing negotiations, said cross-licensing negotiations, and said assignment negotiations;
a second electronic defend component for monitoring infringement of said IP rights;
a third electronic defend component for conducting legal action against said infringement of said IP rights;
a fourth electronic defend component for defending IP invalidation proceedings against said IP rights;
a fifth electronic defend component for monitoring infringement of IP rights of a third party;
a sixth electronic defend component for defending against legal action for said infringement of IP rights of a third party; and
a seventh electronic defend component for initiating IP invalidation proceedings against said IP rights of a third party.

16. The computerized system according to claim 10, wherein said influence computer module includes at least one of:
a first electronic influence component for determining how current and proposed standards, legal and regulatory decisions, and policies affect said business strategies and said IP rights;
a second electronic influence component for participating in standards organizations;
a third electronic influence component for lobbying legislative, regulatory and judicial decisions;
a fourth electronic influence component for prioritizing actions of said second electronic influence component and said third electronic influence component; and
a fifth electronic influence component for tracking and reporting on said actions of said second electronic influence component and said third electronic influence component.

17. The computerized system according to claim 10, wherein said capitalize computer module includes at least one of:
a first electronic capitalize component for formulating licensing criteria and policies, including terms and conditions and pricing models;
a second electronic capitalize component for forecasting a performance of licensed IP and modifying said budgets based on said forecasting, said performance of licensed IP including revenue generation, profitability, market share, defensive competitive benefits, and return on investment;
a third electronic capitalize component for tracking and reporting on actual performance of licensed IP;
a fourth electronic capitalize component for clustering said IP rights into technological groups; and
a fifth electronic capitalize component for identifying current strengths and weaknesses in said IP portfolio.

18. A method of analyzing a component business model including a plurality of components, each of said plurality of components including at least one capability, said method including, for each of said plurality of components:
determining whether an organization has said at least one capability from said plurality of components, said plurality of components being grouped into
a strategic planning computer module for formulating business strategies for creating and managing inventions and IP rights, said strategic planning module including at least one electronic database having data for formulating said business strategies,
an invent computer module for managing creation of said inventions based on said business strategies,
an IP creation computer module for determining value of said inventions and creating an IP portfolio, said creating of said IP portfolio including creating said IP rights based on said determining of said value and said business strategies,
an IP administration computer module for managing said IP rights based on said business strategies including extension, maintenance and retirement of said IP rights, measuring performance of said business strategies, creating and modifying budgets, and setting guidelines for IP counsel,
a defend computer module for defending against infringements and invalidations of said IP rights based on said business strategies and monitoring market and competitor actions to develop risk management plans,
an influence computer module including a standards influencing unit, a legal and regulatory influencing unit, and a policy influencing unit, and
a capitalize computer module for identifying potential licensees and potential assignees of said IP rights, and managing licensing negotiations, cross-licensing negotiations, and assignment negotiations based on said business strategies;
determining whether said organization needs said at least one capability;
determining an ability of said organization to deliver said at least one capability; and
generating a road map to enable said organization to at least one of create and improve said at least one capability.

19. The method according to claim 18, further including identifying at least one strategic planning capability of said at least one capability in said strategic planning computer module, said strategic planning computer module including at least one of:
a first electronic strategic planning component for formulating a strategy to defend against said infringements and invalidations of said IP rights;
a second electronic strategic planning component for formulating a target level of business performance, said business performance including meeting needs of customers, providing at least one of new products and new services, and aligning said business strategies with the marketplace;
a third electronic strategic planning component for formulating a strategy to acquire IP rights from third parties;
a fourth electronic strategic planning component for formulating a strategy for internal utilization of said IP rights;
a fifth electronic strategic planning component for identifying potential business opportunities for said inventions and said IP rights;
a sixth electronic strategic planning component for identifying potential threats to said business strategies; and
a seventh electronic strategic planning component for directing said research and development towards said potential business opportunities and said potential business threats.

20. The method according to claim 18, further including identifying at least one invent capability of said at least one capability in said invent computer module, said invent computer module including at least one of:
a first electronic invent component for allocating a research and development budget;
a second electronic invent component for setting an invention quantity target and an invention quality target;
a third electronic invent component for determining whether said invention quantity target and said invention quality target are satisfied; and
a fourth electronic invent component for inventor training and inventor incentives.

21. The method according to claim 18, further including identifying at least one IP creation capability of said at least one capability in said IP creation computer module, said IP creation computer module including at least one of:
a first electronic IP creation component for formulating an IP creation target;
a second electronic IP creation component for determining whether said IP creation target is satisfied;
a third electronic IP creation component for managing outside IP counsel and agents;
a fourth electronic IP creation component for filing and prosecuting patent applications, trademark applications, and copyright applications;
a fifth electronic IP creation component for creating trade secrets; and
a sixth electronic IP creation component for measuring a performance of said IP rights.

22. The method according to claim 18, further including identifying at least one IP administration capability of said at least one capability in said IP administration computer module, said IP administration computer module including at least one of:
a first electronic IP administration component for forecasting a performance said inventions and said IP rights; and
a second electronic IP administration component for setting IP policies, said IP policies including management of said IP portfolio, IP quality, and investment in IP.

23. The method according to claim 18, further including identifying at least one defend capability of said at least one capability in said defend computer module, said defend computer module including at least one of:
a first electronic defend component for tracking and reporting on revenue-to-product inventory ratios, performance against risk tolerance, and effectiveness of said licensing negotiations, said cross-licensing negotiations, and said assignment negotiations;
a second electronic defend component for monitoring infringement of said IP rights;
a third electronic defend component for conducting legal action against said infringement of said IP rights;
a fourth electronic defend component for defending IP invalidation proceedings against said IP rights;
a fifth electronic defend component for monitoring infringement of IP rights of a third party;
a sixth electronic defend component for defending against legal action for said infringement of IP rights of a third party; and
a seventh electronic defend component for initiating IP invalidation proceedings against said IP rights of a third party.

24. The method according to claim 18, further including identifying at least one influence capability of said at least one capability in said influence computer module, said influence computer module including at least one of:
a first electronic influence component for determining how current and proposed standards, legal and regulatory decisions, and policies affect said business strategies and said IP rights;
a second electronic influence component for participating in standards organizations;
a third electronic influence component for lobbying legislative, regulatory and judicial decisions;
a fourth electronic influence component for prioritizing actions of said second electronic influence component and said third electronic influence component; and
a fifth electronic influence component for tracking and reporting on said actions of said second electronic influence component and said third electronic influence component.

25. The method according to claim 18, further including identifying at least one capitalize capability of said at least one capability in said capitalize computer module, said capitalize computer module including at least one of:
a first electronic capitalize component for formulating licensing criteria and policies, including terms and conditions and pricing models;
a second electronic capitalize component for forecasting a performance of licensed IP and modifying said budgets based on said forecasting, said performance of licensed IP including revenue generation, profitability, market share, defensive competitive benefits, and return on investment;
a third electronic capitalize component for tracking and reporting on actual performance of licensed IP;
a fourth electronic capitalize component for clustering said IP rights into technological groups; and
a fifth electronic capitalize component for identifying current strengths and weaknesses in said IP portfolio.
